(19) United States
(12) Patent Application Publication
(10) Pub. No.: US 2016/0288812 A1
(43) Pub. Date: Oct. 6, 2016

(54) "Cart Buddy" Conventional Shopping Cart Anti-viral Handle Cover and Armrest

(71) Applicants: Howard Wayne Bailey, Blue Eye, MO (US); Leanne Bethune Bailey, Blue Eye, MO (US)

(72) Inventors: Howard Wayne Bailey, Blue Eye, MO (US); Leanne Bethune Bailey, Blue Eye, MO (US)

(21) Appl. No.: 14/968,864

(22) Filed: Dec. 14, 2015

(51) Int. Cl. B62B 5/06

(52) U.S. Cl. CPC B62B 5/069

(57) ABSTRACT

Cushioned handle to cover a common, conventional shopping cart handle, preventing a shopper's hands from coming in contact with the cart handle. Additionally, offers a comfortable rest area for forearms while shopping. User does not come in contact with handle. Cover slips over handle and is secured in place. Shopping complete, cover is removed. The part that touched the handle is not exposed to the user. The handle cover comes with its own carrying case, which has a carrying handle. Once home, the handle cover is removed from its case and the foam form insert is removed, the cover goes straight into the clothes washer. Once dry, the foam form is re-inserted. The spread of germs, viruses and other disease-causing micro-organisms which can lie on the handle are never touched and end up in the washer.

### PRIOR PUBLICATION DATA

| Document Identifier | Publication Date |
|---|---|
| NONE | NONE |

### RELATED U.S. PATENT DOCUMENTS

| Application Number | Filing Date | Pat. No. | Issue Date |
|---|---|---|---|
| 12/985,897 | Jan. 6, 2011 | 8,109,524 | Feb. 7, 2012 |

### REFERENCES CITED [REFERENCED BY]

### U.S. Patent Documents

| | | |
|---|---|---|
| 12/462,761 | Aug. 10, 2009 | Badgley & Roberts |
| Primary Examiner: | | |
| Assistant Examiner: | | |

### BACKGROUND OF THE INVENTION

1. Field of the Invention

This invention relates to a cylindrical foam form covered by a heavy pile fleece fabric that encompasses the tubular handle on conventional shopping carts (e.g., such as that common to a grocery shopping cart). The fabric covered foam form has a lengthwise slit opening into a inside diameter that matches most of the carts in the market place today. The fabric covered foam form is pushed onto the cart handle without the necessity of the user to touch the handle during installation, use or removal.

The fabric portion that actually touches the cart handle is never exposed to the user. Once home, the user removes the foam form from the cover and washes the cover in the clothes washer. Once dry, the foam form is re-inserted into the cover and is ready for the next shopping trip. Thus the user is not exposed to germs, viruses and similar disease-causing micro-organisms that can lie on the surface of a shopping cart handle.

2. Background Art

The basis of this invention was to seek out a comfortable armrest to use while shopping, as many people, including ourselves, rest our forearms on the shopping cart handle while pushing and stopping to browse products while shopping.

The side benefit of this discovery is its anti-viral property. It is known that germs, viruses and potentially health-threatening bacteria are found on a variety of handles such as, for example, shopping cart handles, door handles, public transportation handles, faucet handles, and the like that are frequently touched by different individuals. Many viral infections remain untreatable, and the availability of effective anti-viral drugs and vaccines is somewhat limited. One manner to limit the transmission of viral infections and disease is for individuals to frequently wash their hands. However, hand washing facilities are not always readily available throughout an individual's day. Another means to reduce the spread of disease is to prevent one's hands from coming into direct contact with the handle surfaces on which such disease-causing micro-organisms lie. That is where the Cart Buddy shines. It is placed on the cart and secured in place by straps, used and removed all without the necessity of the user actually touching the shopping cart handle.

Accordingly, it would be desirable to have a cover of your own that attaches securely to the cart handle that is easy to apply, use and remove, all the while the individual's hands do not come into direct contact with the handle and any disease-causing micro-organisms which lie thereon.

### SUMMARY OF THE INVENTION

In general terms, a personal, comfortable shopping cart armrest that doubles as a virus deterrent, as the user's hands and forearms do not come in direct contact with the shopping cart handle. The cover is washable, and therefore sanitary for use as long as proper maintenance is maintained by the user.

### BRIEF DESCRIPTION OF THE DRAWINGS

FIG. 1 Picture 1 the Cart Buddy placed on the shopping cart ready for use, and Picture 2 shows a person leaning on the comfortable armrest;

FIG. 2 shows the detail of the foam insert and the layout of the initial fabric cut for the cover;

FIG. 3 shows the retaining straps detail noting the size and placement of the “Velcro” type material. (Note: “Velcro” is a trade name for hook and loop type material. Throughout this invention the word “Velcro” will refer to hook and loop type material, not necessarily the product used in manufacturing);

FIG. 4 depicts the placement of the straps from FIG. 3 onto the fabric cut in FIG. 1. And the placement of the three-quarter inch by one inch (¾″×1″) “Velcro” hook used to attach the carrying case to the cover;

FIG. 5 shows the placement and sewing order of the elastic in the open end and the seam sewing. Once the seam is sewn, the closed end is cut to shape as the seam is folded into the center of the thus far sewn fabric. The fabric is then turned inside out and the contoured closed end is sewn from the inside;

FIG. 6 depicts the layout of the “rip-stop nylon” used for the carrying case. Additionally, the placement of the one-quarter inch (¼″) grommet and the folds and sewing of the fabric. Also, the closed end piece is depicted with the three-eighths inch (⅜″) seam marked;

FIG. 7 shows the bottom “closed end” of the carrying case being sewn into the inside out cylinder made in FIG. 6;

FIG. 8 shows the carrying strap detail of the carrying case shown in FIG. 6 and FIG. 7; and

FIG. 9 Picture 1—shows the armrest/anti-viral Cart Buddy being placed onto a shopping cart; Picture 2—shows securing the Cart Buddy with the straps and attaching the user's personal shopping bags; which Picture 3—shows the Cart Buddy removed from the shopping cart, and placed into the carrying case and held by the built-in wrist strap.

### DESCRIPTION OF THE PREFERRED EMBODIMENT

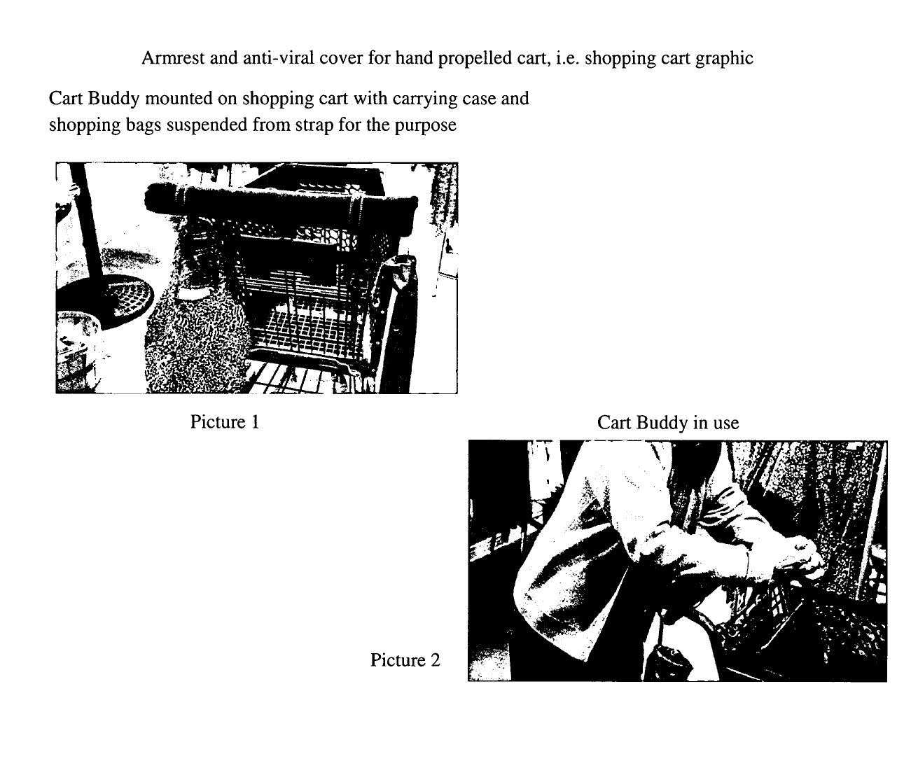

Referring initially to FIG. 1 of the drawings, there is shown a conventional shopping cart, of the kind commonly found in a grocery store, within which a shopper's groceries are transported. As with a conventional shopping cart, the shopping cart of FIG. 1 includes a cylindrical/tubular handle, most of which are about one inch (1″) in diameter around which the shopper's hands are wrapped and to which a pulling or pushing force is applied so as to cause a corresponding force to be applied to the wheels thus moving the shopping cart.

However, on this cart we have added/installed our “Cart Buddy”, which is a foam form encased in a soft heavy pile fleece fabric. One of the straps that secure the handle cover to the handle makes a loop suitable for carrying the user's personal shopping bags. The foam form encased within the heavy pile fleece fabric provides comfort to the user while shopping as they rest their forearms on the cart handle while pushing the cart or pausing to browse or shop.

When installing the “Cart Buddy” onto the handle of the shopping cart, the shopper's hands can avoid direct contact with the handle, as the foam form has a lengthwise slit that allows the patron to simply push the “Cart Buddy” onto the handle without actually touching the handle. By virtue of the foregoing, the shopper's hands will not be exposed to germs, viruses and other disease-causing micro-organisms that may lie on the surface of the handle.

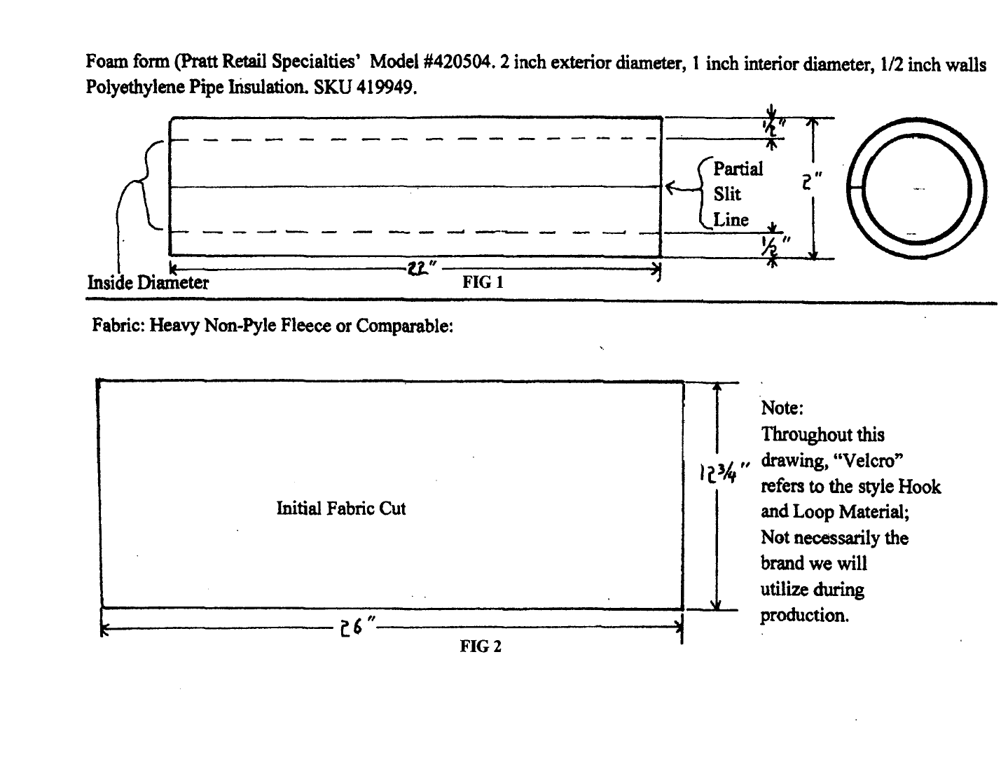

Details of the foam form are depicted in FIG. 2. We are using Pratt Retail Specialties Model #420504, two inch (2″) exterior diameter, one inch (1″) interior diameter, with one-half inch (½″) thick walls Polyethylene Pipe Insulation. SKU 419949 for our foam form. This product normally comes in six foot (6′) lengths, which we cut to size of twenty-two inches with a kitchen serrated knife. During manufacture, we will either order directly from the manufacturer cut to size, if they can accommodate that, or use professional cutting tools to cut to size. We use a standard utility knife to complete opening the lengthwise slit.

Also in FIG. 2, we show the initial cut of the soft heavy pile fleece fabric. This fabric is available at all fabric stores, however, we are looking for a distributor so as to buy direct. This fabric is sold in rolls and we will cut to size twenty-six inches by twelve and three-quarters inches (26″×12¾″).

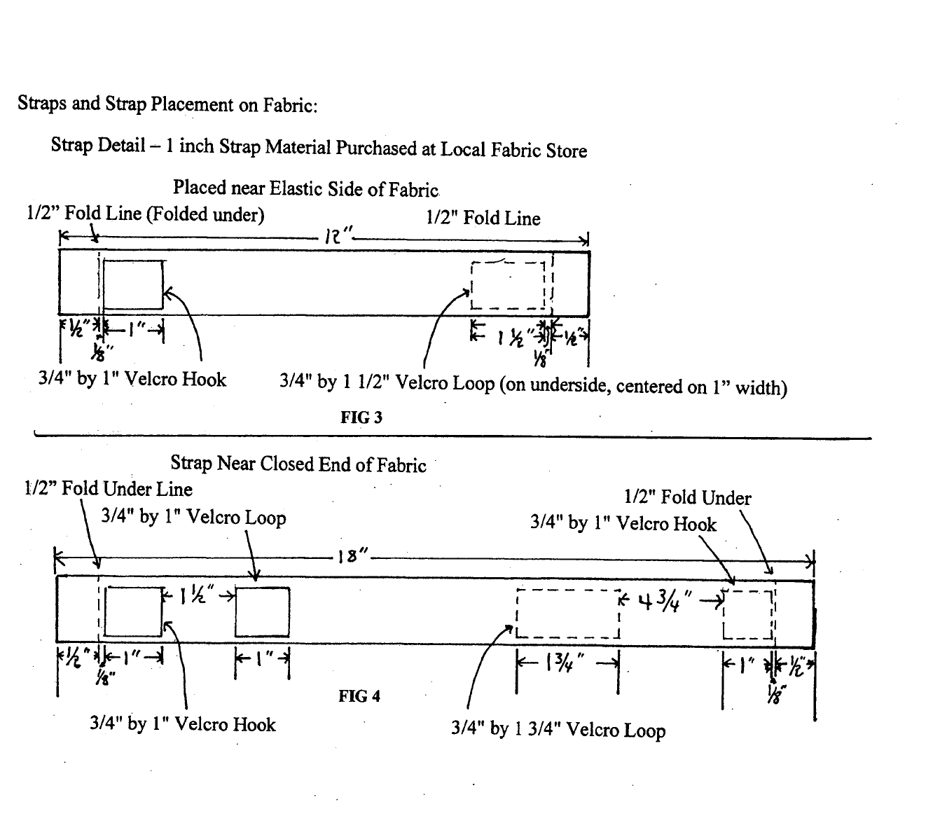

FIG. 3 shows the strapping material detail. We are utilizing Trimtex CAROLACE SKU #2852796 one inch (1″) Polypropylene Strapping Material, and other colors than black with white stitching on the side. We cut one length twelve inches (12″). This allows for one-half inch (½″) fold under where it is sewn to the soft heavy pile fleece fabric. Five-eighths inch (⅝″) from one end we sewed a three-quarters inch (¾″) by one inch (1″) piece of Hook side of “Velcro” type material. On the opposite side of the same twelve inch (12″) strap, we sewed a three-quarters (¾″) by one and one-half inch (1½″) Loop side of “Velcro” type material.

FIG. 3 also shows a eighteen inch (18″) cut of the Trimtex CAROLACE SKU #2852796 one inch (1″) Polypropylene Strapping Material. Again, we leave one-half inch (½″) for fold under when sewing the strap to the soft heavy pile fleece fabric. Five-eighths inch (⅝″) from one end we sewed a one inch (1″) by three-quarters inch (¾″) Hook “Velcro” type material to the strap. Three and one eighth inches from the same end we sewed a one inch (1″) by three-quarters inch (¾″) Loop “Velcro” type material on the same side.

On the opposite side, we allowed a one-half inch (½″) fold under to sew in loose edges. Five-eighths inch (⅝″) from the opposite end we sewed earlier, we sewed a three-quarters inch (¾″) by one inch (1″) Hook “Velcro” type material. Four and three-quarters inches from the edge of the Hook “Velcro” type material, or six and three-eighths inches from the end, we sewed a one and three-quarters inch by three-quarters inch (1¾″×¾″) Loop “Velcro” type material.

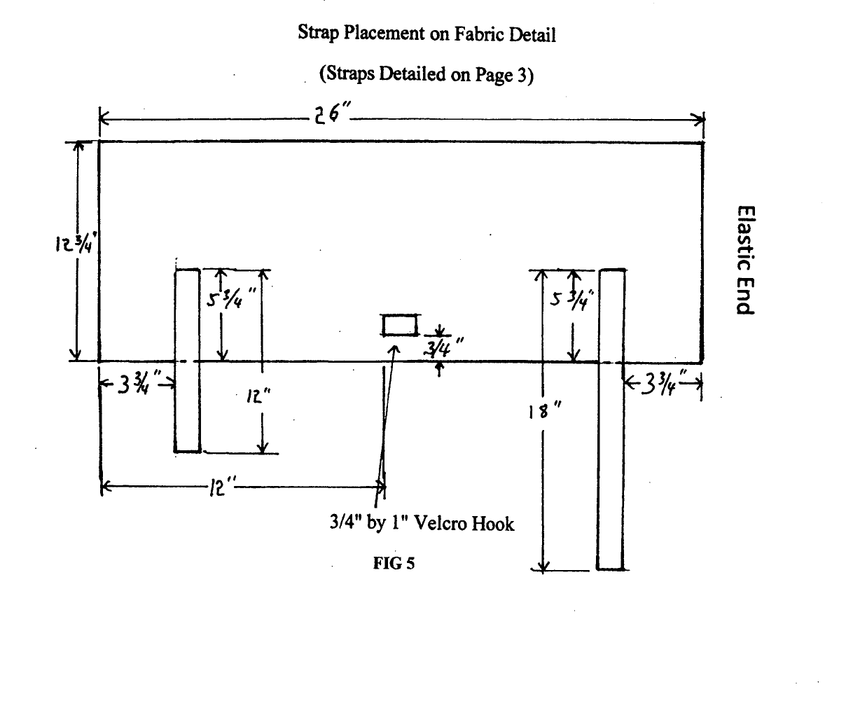

FIG. 4 shows straps from FIG. 3 placement onto the soft heavy pile fleece fabric. Additionally, we sewed a one inch by three-quarters inch (1″×¾″) Hook “Velcro” type material twelve inches (12″) from the side with the twelve inch (12″) strap and three-quarters inch (¾″) from the long edge of the fabric.

The twelve inch (12″) strap from FIG. 3 is sewn three and three-quarters inch (3¾″) from the left edge of the soft heavy pile fleece fabric, and five and three-quarters inches (5¾″) from the long edge. Before sewing, we folded one-quarter inch (¼″) of the strap under and sewed the folded side down onto the fabric sewing a rectangle seven-sixteenths inch wide ( 7/16″) and three sixteenths inch ( 3/16″) long.

The eighteen inch (18″) strap from FIG. 3 is sewn three and three-quarters inch (3¾″) from the right edge of the, soft heavy pile fleece fabric, and five and three-quarters inches (5¾″) from the long edge. Before sewing, we folded one-quarter inch (¼″) of the strap under and sewed the folded side down onto the fabric sewing a rectangle seven-sixteenths inch wide ( 7/16″) and three sixteenths inch ( 3/16″) long.

Both straps are sewn to the good side of the fabric.

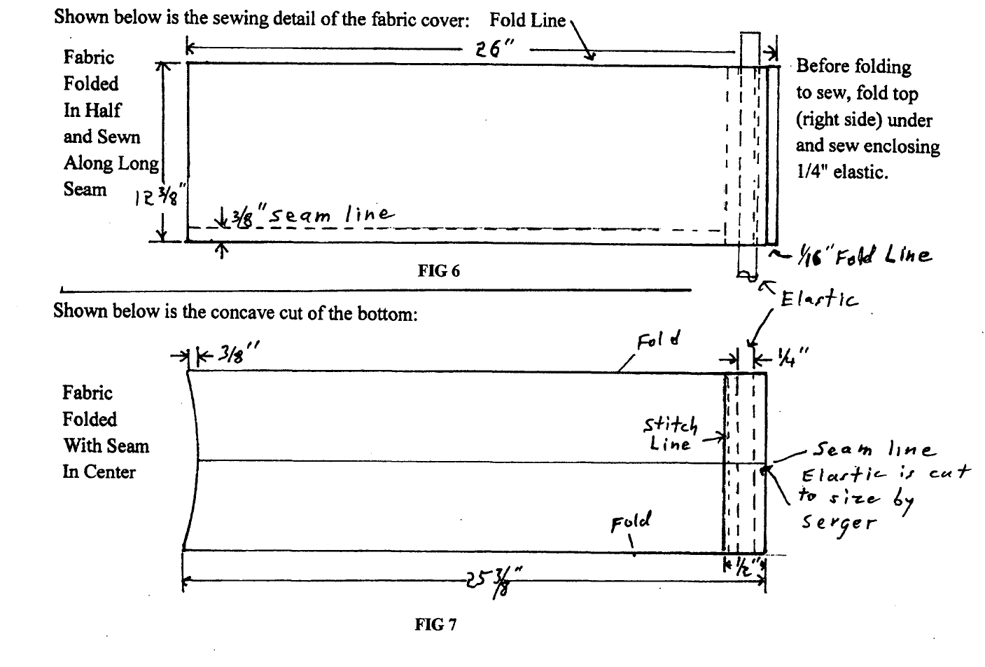

FIG. 5 One end is closed off while the other has elastic allowing the foam form to be removed for cleaning and re-inserted. With the fabric from FIG. 2 wrong side up, we encase one-quarter inch (¼″) wide elastic along a twelve inch (12″) length side. Leaving the elastic on the roll, we folded five-eighths inch (⅝″) of the fabric over the elastic. Folding one-eighth inch (⅛″) under, we encased the elastic by stitching along the folded under side. For now, we left the ends hanging out the enclosure.

We folded the material in half lengthwise, right sides together, and serge a three-eighths inch (⅜″) seam along the long side to within one inch (1″) of the end with the elastic, allowing the elastic not to be sewn in place permanently yet.

Then fold the semi-complete cylinder to where the seam running lengthwise is in the center of one side of the fabric, seam side up. Mark a spot three-eighths inch (⅜″) from short side, without the elastic, on the seam. Using a “French Curve” draw an arc from the three-eighths inch (⅜″) center mark to each of the folded corners. During manufacture, we will use templates. Serge along the line allowing a three-eighths inch (⅜″) seam.

Pull the elastic, still attached to the roll, till the opposite side is even with the edge of the fabric. Holding the cut end of the elastic even with the edge of the fabric, pull the opposite end, still attached to the roll, till the compressed hole is about one and one-half inches (1½″) in diameter. Sew the rest of the un-sewn seam ensuring the elastic does not get loose and slip inside, but both sides are caught in the new hem. Cut the elastic from the roll. Turn the newly created cover right side out.

Insert the foam form inside the newly created arm-rest cover. Once encased, line the seam up with the slit in the foam form. Push the seam inside the slit of the foam form and all the loose material till the cover is snug over the foam form. During production, we will use a jig form to push the fabric inside the foam form.

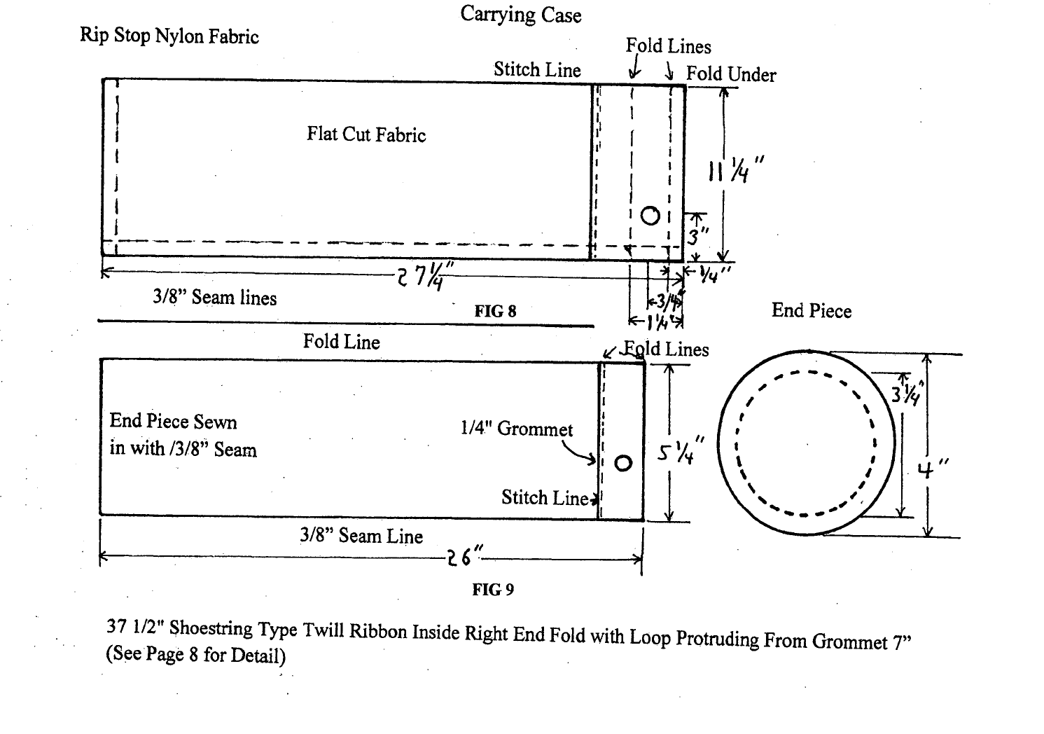

FIG. 6 depicts the cover for the completed “Cart Buddy” armrest of FIG. 5. Using “Rip Stop Nylon” fabric, cut a piece eleven and one-quarter inches wide by twenty-seven and one-quarter inches (11¼″×27¼″) long. This allows a three-eighths inch (⅜″) hem at the bottom and along the side; a fold of one inch (1″) plus one-quarter inch (¼″) to fold under at the top/open side.

On one short end, we installed a one-quarter inch (¼″) diameter grommet three-quarters inch (¾″) from the short edge and three inches (3″) from the raw edge of the long side; finished side facing the good side of the fabric.

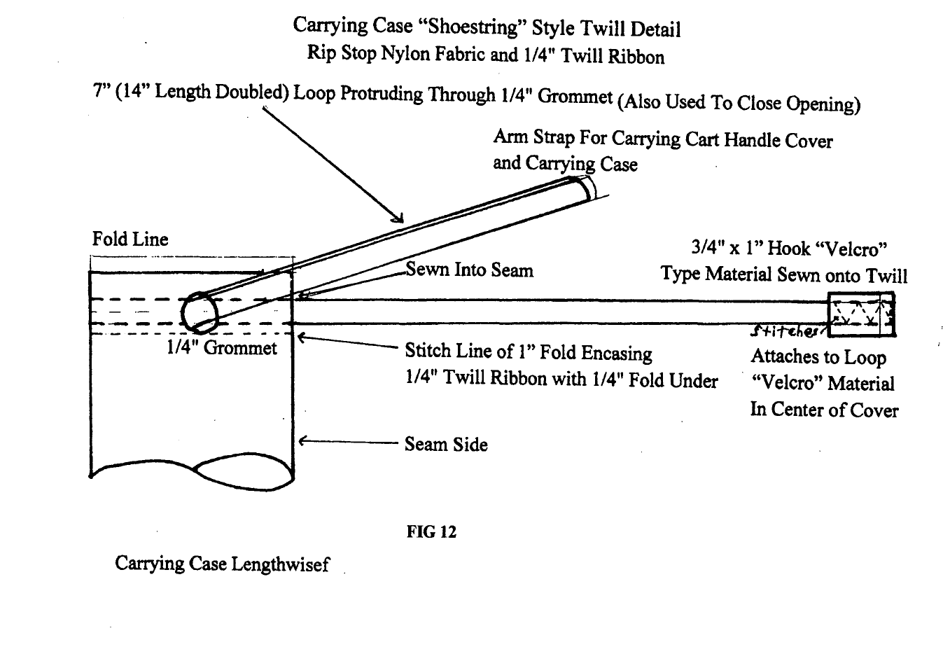

Please refer to FIG. 8. Using “Trimtex CAROLACE” three-eighths inch (⅜″) wide Twill Tape SKU 2852713, and other assorted colors; cut a thirty-seven and one-half inch (37½″) length. The length of the drawstring is three fold: 1) to connect the cover to the arm-rest cover, 2) to allow for a seven inch (7″) loop (fourteen inch (14″) total length) to be used as a handle to slip an arm through, and 3) to draw the top closed to hold the arm-rest inside.

Please refer to FIG. 8, from the wrong side of the fabric, pull the twill tape through the one-quarter inch (¼″) grommet to form a seven inch (7″) loop. Pull one end of the twill till it extends almost two inches (2″) beyond the three inch (3″) length of fabric. Stretch the rest out the opposite direction.

Fold one and one-quarter inch (1¼″) of the eleven and one-quarter inches (11¼″) side with the grommet and twill tape of the rip stop fabric over the twill tape, wrong side to wrong side of the fabric. Fold under one-quarter inch (¼″) of the fabric and sew the resultant encasement encompassing the twill tape.

Fold the right sides of the rip stop nylon fabric together lengthwise and serge the long sides together from the end without the twill tape to within one inch (1″) from the end with the twill tape.

Referring to FIG. 8, pull the short end of the twill tape even with the long edge of the rip stop nylon fabric. Pull the twill tape through the grommet to form a loop five and one-quarter inches (5¼″) long (when the loop is pulled to close the opening, it will become a seven inch (7″) loop). Smooth remaining twill tape to the opposite side and beyond, leaving approximately fifteen inches (15″) extended beyond the rip stop nylon fabric. Finish sewing the long seam with a sewing machine stitching over the two (2) pieces of twill tape.

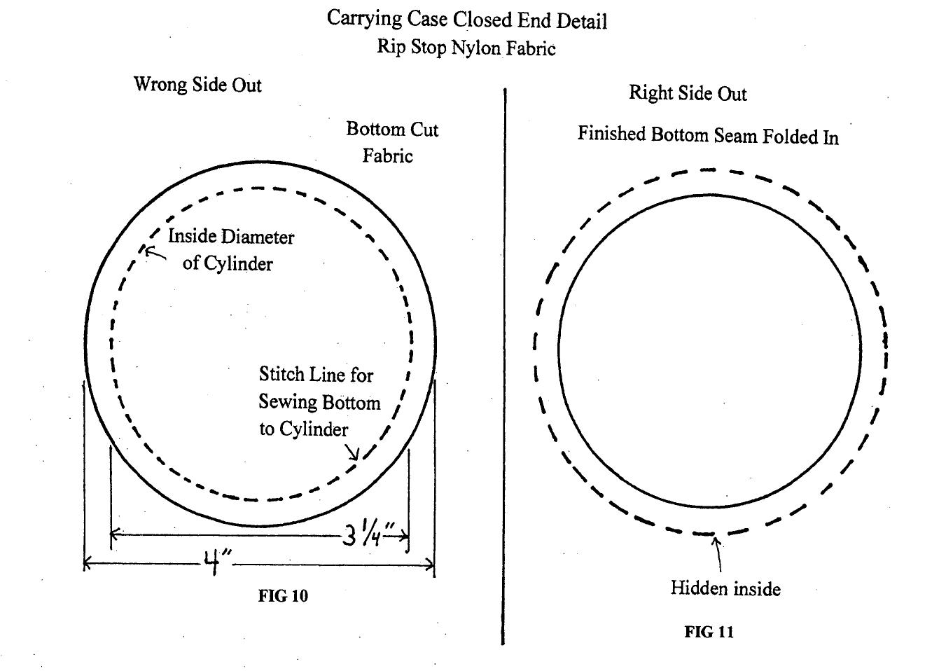

FIG. 7 from a new piece of rip stop nylon fabric, cut a round piece of fabric four inches (4″) in diameter. With the cylinder from FIG. 6 wrong side out, place the four inch (4″) diameter circle right side to right side and sew in place with a three-eighths inch (⅜″) hem.

Turn the finished cylinder right-side out leaving the extra fifteen inches (15″) of twill tape hanging from the inside of the sewn edge. On the end of the fifteen inch (15″) twill tape, sew a three-quarter inch (¾″) by one inch (1″) Loop side of “Velcro” type material. This is used to attach the cover to the armrest.

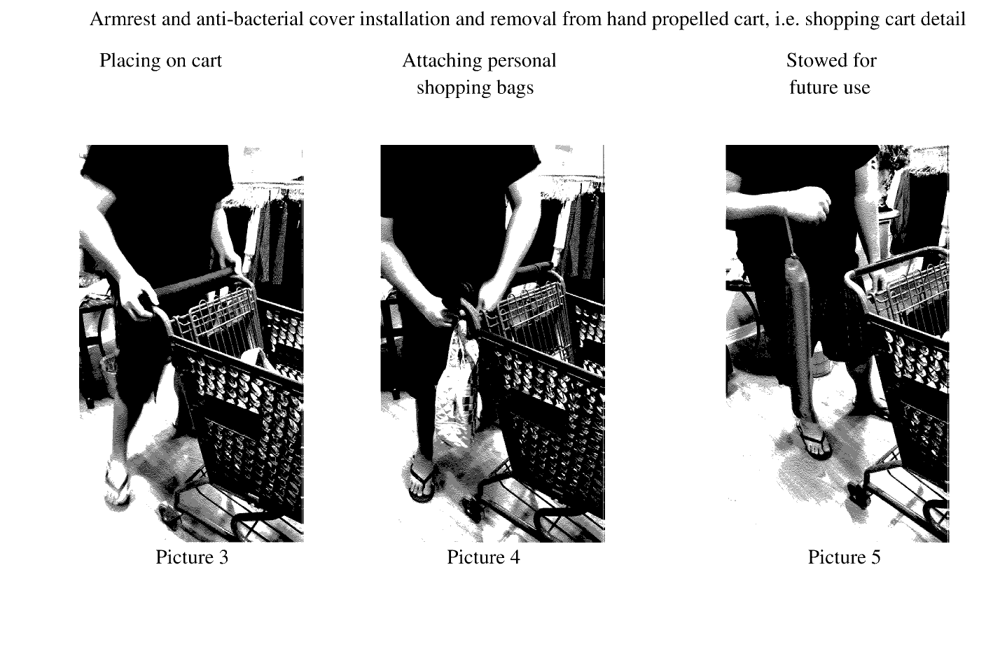

FIG. 9 shows the “Cart Buddy” being placed/pushed onto a standard shopping cart handle; The straps circled around the “Cart Buddy” and the personal shopping bags hung from the eighteen inch (18″) strap; and the “Cart Buddy” back in its carrying case ready to be taken home and washed so it will be ready for the next shopping trip.

### Instructions For Use

Remove the “arm-rest” from the cover. Unwrap the one inch (1″) twill straps and slip the slit end of the “arm-rest” over the cart handle.

Feed the fifteen inch (15″) length of twill tape toward the side of the cart with the short strap, then pull the short strap around the handle till the hook and loop Velcro type material ends meet each other.

Pull the long strap around the cart handle till the hook and loop Velcro type material meet. Then take the remaining length of the strap and loop it through your personal non-disposable shopping bags, then hook the end with the Velcro type material to the remaining piece of Velcro type material thus holding your shopping bags.

While shopping, loosen the twill strap and remove a shopping bag as needed, then re-connect the Velcro type material to secure the remaining unused shopping bags.

When finished shopping, unhook the two one inch (1″) straps and pull the arm-rest off the cart handle from one side toward the other. Wrap the one inch (1″) straps around the arm-rest. Slip the arm-rest inside the attached cover and pull the protruding loop from the one-quarter inch (¼″) grommet. Slip the loop over your arm and head to your vehicle.

### Complete

This completes the Armrest and Antibacterial Cover for Hand Propelled Cart i.e. Shopping Cart “Cart Buddy”.

The invention claimed is:

1. A method for making a cushioned armrest and a protective guard to cover the standard tubular shopping cart handle, or a large part of the handle of oversized shopping carts utilized by the large box type stores/warehouse type carts. The individual's hands and/or forearms never touch the handle, or the part of the cover that covers the handle, during installation, use and removal of the cover. The cover encompasses the complete circumference of the tubular handle. The part of the cover that actually touches the handle is not exposed to the individual user.

2. The method recited in claim 1, provides a cushioned foam armrest, covered by a soft heavy pile fleece fabric, providing comfort to the user while shopping as they rest their forearms on the conventional shopping cart handle while shopping, browsing or resting.

3. The method recited in claim 1, provides protection for the user from coming in direct contact with the conventional shopping cart handle during installation, use and removal of the cover. The part of the cover that actually encompasses the shopping cart handle is not exposed to the user. Once the user returns home, they can remove the foam form and place the cover in the clothes washer. Once dry, replace the foam form and it is ready for the next shopping trip.

4. The method recited in claim 1, includes a foam form to cushion the users hands and/or forearms while resting or leaning on the shopping cart while shopping.
